(19) United States
(12) Patent Application Publication
(10) Pub. No.: US 2002/0060259 A1
(43) Pub. Date: May 23, 2002

(54) Film cassette

(76) Inventor: Eiichi Kitayama, Tokyo-to (JP)

Correspondence Address: PARKHURST, WENDEL, L.L.P., Suite 210, 1421 Prince Street, Alexandria, VA, 22314-2805, US

(21) Appl. No.: 09/825,864

(22) Filed: Apr. 5, 2001

(30) Foreign Application Priority Data
Apr. 7, 2000 (JP) 2000-106156

(51) Int. Cl. G03B 23/02

(52) U.S. Cl. 242/338.1; 242/343.2

(57) ABSTRACT

A film cassette consists of a relatively small number of parts and is capable of effectively preventing the slackening of a film held therein during transportation. The film cassette has a package containing a feed bobbin (40) and a takeup bobbin (50) and including a first half case (10) and a second half case (20). Positioning tongues (20b) formed integrally with the second half case (20) determine the axial positions of the feed bobbin (40) and the takeup bobbin (50). Projections (10a) formed on the first half case (10) engage in grooves (40a, 50a) formed in wheels (40c, 50c) of the feed bobbin (40) and the takeup bobbin (50), respectively to prevent the feed bobbin (40) and the takeup bobbin (50) from unnecessary rotation during transportation. The first half case (10) and the second half case (20) are fastened together by hooks (12) formed integrally with the first half case (10).

### BACKGROUND OF THE INVENTION

1. Field of the Invention

The present invention relates to a film cassette for holding a length of film, such as a thermal transfer film and, more particularly, to a film cassette provided with a film holding unit including a feed bobbin holding a length of film and a takeup bobbin for taking up the length of film unwound from the feed bobbin.

2. Description of the Related Art

A sublimation transfer recording system is a widely noticed thermal transfer recording system. The sublimation transfer recording system heats a thermal transfer sheet formed by coating a base sheet, such as a polyester film, with a thermal transfer layer containing a sublimable dye, with a heating means, such as a thermal head or a laser, to form an image on a thermal transfer recording sheet.

Generally, a thermal transfer film, i.e., a thermal transfer sheet, for the sublimation transfer recording system is held in a film cassette provided with a film unit including a feed bobbin holding the thermal transfer film and a takeup bobbin for taking up the thermal transfer film unwound from the feed bobbin. The film cassette is loaded into a thermal transfer printer and the thermal transfer film is fed continuously for printing.

It is possible that either the feed bobbin or the takeup bobbin, or both the feed bobbin and the takeup bobbin turn, the thermal transfer film slackens and the thermal transfer film is damaged during the transportation of the film cassette.

The conventional film cassette is provided with a locking mechanism for preventing the feed bobbin and the takeup bobbin from turning. More concretely, the conventional film cassette has a package provided with locking projections, and bobbins provided with recesses formed in their ends so as to correspond to the locking projections of the package. The locking projections of the package are engaged in the recesses of the bobbins and the bobbins are restrained from axial movement during transportation to keep the locking projections of the package engaged in the recesses of the bobbins. A metal plate spring attached to the package is used as a member for restraining the bobbins from axial movement.

The conventional film cassette provided with the metal plate spring attached to the package to restrain the bobbins from axial movement needs many parts, much assembling work and hence a high manufacturing cost.

The metal plate spring is apt to be deformed during the assembly of the film cassette and the yield of a film cassette assembly line is low.

When assembling the conventional film cassette by putting the bobbins in a lower half case while the bobbins are biased by the metal plate spring and putting an upper half case on the lower half case, the bobbins put in the lower half case are apt to be dislocated. Therefore, an additional process of temporarily fastening the bobbins to the lower half case before putting the upper half case on the lower half case, which further increases the manufacturing cost.

### SUMMARY OF THE INVENTION

The present invention has been made in view of such problems and it is therefore an object of the present invention to provide a film cassette capable of effectively preventing a film from slackening during transportation, consisting of a relatively small number of parts and capable of being easily assembled.

According to a first aspect of the present invention, a film cassette comprises: a feed bobbin holding a length of film; a takeup bobbin capable of taking up the film unwound from the feed bobbin; a package having first and second half cases and holding the feed bobbin and the takeup bobbin therein; and a detaining mechanism for restraining at least the feed bobbin or the takeup bobbin from rotation in the first and the second half case by engaging at least either the feed bobbin or the takeup bobbin with at least either the first half case or the second half case; wherein at least either the first half case or the second half case is provided integrally with a positioning tongue for positioning at least either the feed bobbin or the takeup bobbin in the first and the second half case, and the positioning tongue positions at least either the feed bobbin or the takeup bobbin such that the detaining mechanism remains engaged until a releasing force exceeding a predetermined level is applied to at least either the feed bobbin or the takeup bobbin.

In the film cassette according to the first aspect of the present invention, it is preferable that at least either the feed bobbin or the takeup bobbin is axially movable in the first and the second half case, and the positioning tongue is in contact with an end of at least either the feed bobbin or the takeup bobbin to fix the axial position of at least either the feed bobbin or the takeup bobbin. It is also preferable that the positioning tongue is not warped or deformed and held in a free state while the releasing force is not applied to at least either the feed bobbin or the takeup bobbin. It is also preferable that the positioning tongue is warped or deformed by a predetermined amount to apply a predetermined biasing force to at least either the feed bobbin or the takeup bobbin when the releasing force is not applied to at least either the feed bobbin or the takeup bobbin. Furthermore, it is preferable that the first half case is provided with bearing parts for supporting shafts of the feed bobbin and the takeup bobbin, and the second half case to be joined to the first half case is provided integrally with the positioning tongue for positioning at least either the feed bobbin held in the first half case or the takeup bobbin held in the first half case. It is preferable that at least either the first half case or the second half case is provided with fastening means for fastening together the first and the second half case. It is preferable that the fastening means are a plurality of elastic hooks formed at least on either the first half case or the second half case. Preferably, the length of film is a thermal transfer film.

According to a second aspect of the present invention, a film cassette comprises: a feed bobbin holding a length of film; a takeup bobbin capable of taking up the film unwound from the feed bobbin; and a package having first and second half cases and holding the feed bobbin and the takeup bobbin therein, wherein at least either the first half case or the second half case is provided with fastening means for fastening together the first and the second half case.

In the film cassette according to the second aspect of the present invention, it is preferable that the fastening means are a plurality of elastic hooks formed integrally with at least the first half case or the second half case.

The film cassette in the first aspect of the present invention has the positioning tongue formed integrally with at least either the first half case or the second half case for positioning at least either the feed bobbin or the takeup bobbin in the first and the second half case, and the positioning tongue positions the feed bobbin and/or the takeup bobbin such that the detaining mechanism keeps the feed bobbin and/or the takeup bobbin engaged with the first half case until a releasing force exceeding a predetermined level is applied to the feed bobbin and the takeup bobbin. Thus the film cassette is capable of effectively preventing the slackening of the film, has a relatively small number of parts and can be easily assembled.

The film cassette in the second aspect of the present invention has the fastening means formed integrally with at least either the first half case or the second half case to fasten the first half case and the second half case together. Thus, the first and the second half case can be easily and surely assembled.

### BRIEF DESCRIPTION OF THE DRAWINGS

FIG. 1 is an exploded perspective view of a film cassette in a preferred embodiment of the present invention;

FIG. 2 is an enlarged perspective view of a part II in the film cassette shown in FIG. 1; and

FIG. 3 is a sectional view of the assembled film cassette shown in FIG. 1 taken on line III-III in FIG. 1.

### DESCRIPTION OF THE PREFERRED EMBODIMENTS

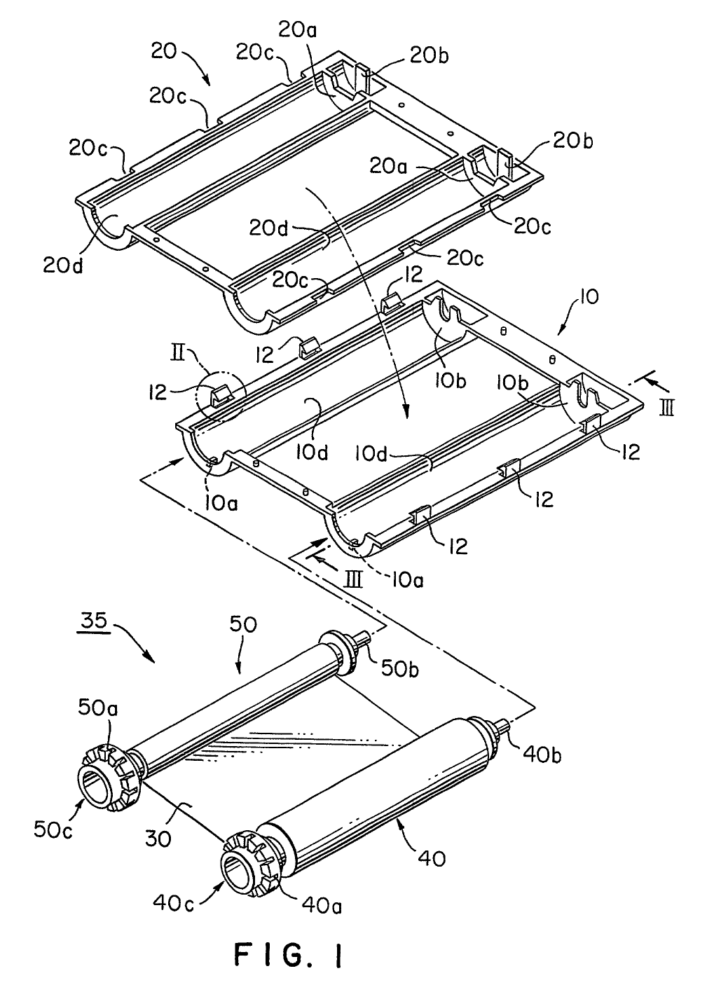

A film cassette in a preferred embodiment of the present invention will be described with reference to the accompanying drawings. FIGS. 1 to 3 show the film cassette embodying the present invention.

In FIG. 1, indicated at 30 is a thermal transfer film (a length of film) to be used by a thermal transfer printer for printing characters and the like by a thermal transfer method. The thermal transfer film is wound closely on a feed bobbin 40 and a leading edge part of the thermal transfer film is attached to a takeup bobbin 50 with an adhesive tape or the like. The feed bobbin 40 and the takeup bobbin 50 form a film holding unit 35.

The feed bobbin 40 feeds the thermal transfer film 30. The feed bobbin 40 has a substantially cylindrical shape. A wheel 40c provided with grooves 40a is mounted on one end part of the feed bobbin 40 and a shaft 40b projects from the other end part of the same.

The takeup bobbin 50 takes up the thermal transfer film unwound from the feed bobbin 40. The takeup bobbin 50 has the same shape as that of the feed bobbin 40. A wheel 50c provided with grooves 50a is mounted on one end part of the takeup bobbin 50 and a shaft 50b projects from the other end part of the same. In an initial state, the thermal transfer film is not wound on the takeup bobbin 50 and only the leading edge part of the thermal transfer film 30 is attached to the takeup bobbin 50 with an adhesive tape or the like.

The film holding unit 35 including the feed bobbin 40 and the takeup bobbin 50 is held in a package including a first half case 10 and a second half case 20.

The first half case 10 is a member forming a part of the package and is formed of an elastic plastic material. The first half case 10 has two semicylindrical parts 10d of a semicircular cross section. The feed bobbin 40 and the takeup bobbin 50 are placed in the semicylindrical parts 10d, respectively. The first half case 10 is provided with two stopping projections 10a respectively for the feed bobbin 40 and the takeup bobbin 50, and two bearing parts 10b respectively for the feed bobbin 40 and the takeup bobbin 50. The first half case 10 is provided with three hooks (fastening means) 12 on each of its side edge parts. The feed bobbin 40 and the takeup bobbin 50 are received in the semicylindrical parts 10d so as to be axially movable in a predetermined range.

The stopping projections 10a of the first half case 10 engage in the grooves 40a and 50a of the wheels 40c and 50c of the feed bobbin 40 and the takeup bobbin 50, respectively. The stopping projections 10a of the first half case 10, and the wheels 40c and 50c provided with the grooves 40a and 50a of the feed bobbin 40 and the takeup bobbin 50 constitute detaining mechanisms for restraining the feed bobbin 40 and the takeup bobbin 50 from rotation, respectively.

The bearing parts 10b of the first half case 10 have a shape substantially resembling the letter U. The bearing parts 10b support the shafts 40b and 50b of the feed bobbin 40 and the takeup bobbin 50, respectively.

The hooks 12 of the first half case 10 are formed integrally with the first half case 10 and are moderately elastic.

The second half case 20 is, similarly to the first half case 10, a member forming a part of the package and is formed of an elastic plastic material. The second half case 20 has two semicylindrical parts 20d of a semicircular cross section. Parts of the feed bobbin 40 and the takeup bobbin 50 placed in the first half case 10, protruding from the first half case 10 are received in the second half case 20. The second half case 20 is provided with two shaft holding parts 20a for holding the shafts 40b and 50b of the feed bobbin 40 and the takeup bobbin 50 on the bearing parts 10b of the first half case 10, respectively, and two positioning tongues 20b for positioning the shafts 40b and 50b of the feed bobbin 40 and the takeup bobbin 50, respectively. The second half case 20 is provided with three recesses 20c on each of its side edge parts.

The shaft holding parts 20a of the second half case 20 holds the shafts 40b and 50b of the feed bobbin 40 and the takeup bobbin 50 on the bearing parts 10b of the first half case 10 when the first half case 10 and the second half case 20 are joined together.

The positioning tongues 20b of the second half case 20 are thin tongues formed integrally with the second half case 20. The positioning tongues 20b are in contact with the ends of the shafts 40b and 50b of the feed bobbin 40 and the takeup bobbin 50 to position the feed bobbin 40 and the takeup bobbin 50 with respect to an axial direction in the first half case 10. The positioning tongues 20b regulates the axial positions of the feed bobbin 40 and the takeup bobbin 50 so that the stopping projections 10a of the first half case 10 remain engaged in the grooves 40a and 50a of the wheels 40c and 50c of the feed bobbin 40 and the takeup bobbin 50 until a releasing force exceeding a predetermined level is applied to the feed bobbin 40 and the takeup bobbin 50. The positioning tongues 20b are not warped or deformed and remain in a natural shape while the releasing force is not applied to the feed bobbin 40 and the takeup bobbin 50.

The recesses 20c of the second half case 20 correspond to the hooks 12 of the first half case 10, respectively. When joining the second half case 20 to the first half case 10, the hooks 12 of the first half case 10 engage in the recesses 20c of the second half case 20, respectively, to hold the first half case 10 and the second half case 20 together by the resilience of the hooks 12.

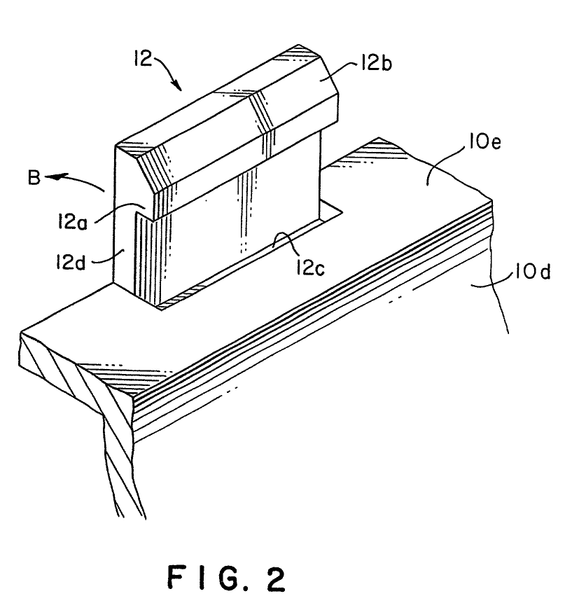

Referring to FIG. 2, each of the hooks 12 has a catching part 12a and a leg part 12d extending from the parting surface 10e of the first half case 10 to the catching part 12a. When the first half case 10 and the second half case 20 are joined together, the catching parts 12a of the hooks 12 are fitted in the recesses 20c of the second half case 20.

The hook 12 is elastic and bends elastically in the direction of the arrow B when the catching part 12a of the hook 12 drops in the recess 20c. Thus, the catching parts 12a of the hooks 12 can be easily fitted in the recesses 20c, respectively.

The catching part 12a of each hook 12 is provided with a beveled surface 12b. When fitting the catching part 12a of the hook 12 in the recess 20c, the catching part 12a can be guided by a peripheral edge of the second half case 20. The catching part 12a may be provided with any suitable surface other than the beveled surface 12b, such as a curved surface, provided that the surface is able to guide the catching part 12a of the hook 12 along the peripheral edge of the second half case 20. A beveled surface may be formed in a part to be in contact with the hook 12 of the edge of the recess 20c of the second half case 20 instead of forming the beveled surface in the hook 12.

A depression 12c is formed in a part of the parting surface 10e of the first half case 10 on the inner side of the leg part 12d of the hook 12. The depression 12c is formed to avoid making pattern draw impossible due to the formation of an undercut in the catching part 12a owing to the parting of a mold. When a slide mold is used, molding is possible even if the mold is not provided with any depression and hence the depression 12c is unnecessary.

The operation of the film cassette thus constructed will be described hereinafter.

Referring to FIG. 1, the film unit 35 including the feed bobbin 40 and the takeup bobbin 50 is put in the first half case 10. More specifically, the feed bobbin 40 and the takeup bobbin 50 are placed in the semicylindrical parts 10d with the respective shafts 40b and 50b of the feed bobbin 40 and the takeup bobbin 50 supported on the bearing parts 10b of the first half case 10. The feed bobbin 40 and the takeup bobbin 50 are axially movable in the semicylindrical parts 10d in a predetermined range.

The second half case 20 is put on the first half case 10 set in a position as shown in FIG. 1 and the second half case 20 is joined to the first half case 10.

The hooks 12 of the first half case 10 are fitted in the recesses 20c of the second half case 20, respectively. The first half case 10 and the second half case 20 are fastened together by the resilience of the hooks 12.

Parts protruding from the first half case 10 of the feed bobbin 40 and the takeup bobbin 50 are received in the semicylindrical parts 20d of the second case 20. The shafts 40b and 50b of the feed bobbin 40 and the takeup bobbin 50 placed in the first half case 10 are held between the bearing parts 10b of the first half case 10 and the shaft holding parts 20a of the second half case 20. In this state, the positioning tongues 20b of the second half case 20 touch the free ends of the shafts 40b and 50b of the feed bobbin 40 and the takeup bobbin 50 to control the axial positions of the feed bobbin 40 and the takeup bobbin 50.

The film cassette thus assembled by holding the film unit 35 in the package formed by joining the first half case 10 and the second half case 20 together is inserted into a thermal printer or the like and is used for printing. More concretely, a predetermined part of the thermal transfer film 30 wound on the feed bobbin 40 held in the first half case 10 and the second half case 20 is fed to a printing position for printing characters and the like. A used part of the thermal transfer film 30 is taken up on the takeup bobbin 50 after printing.

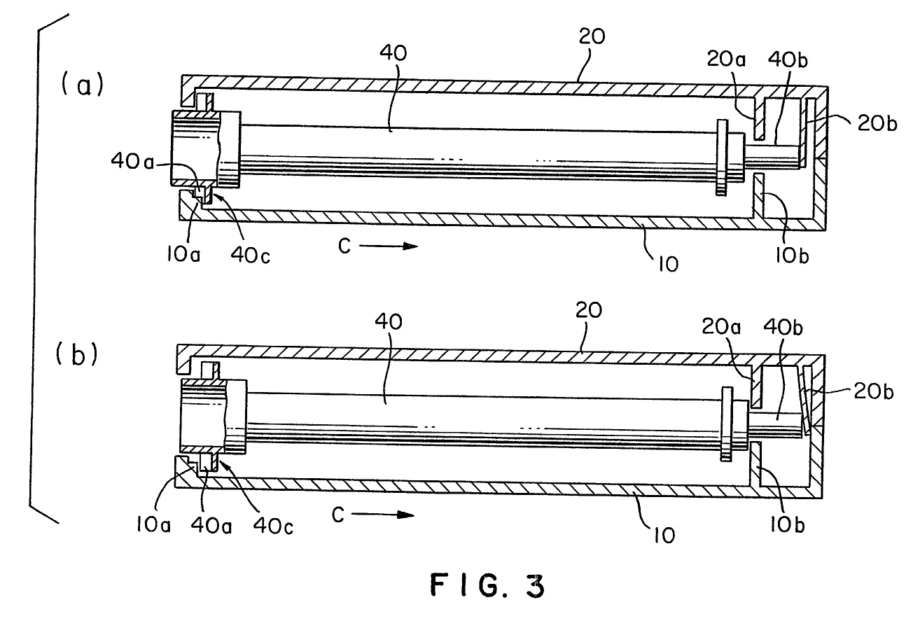

FIG. 3 is a view of assistance in explaining an operating mode of the film cassette, in which FIG. 3(a) shows the film cassette in a nonprinting state where the film cassette is not inserted in a thermal transfer printer and is not used for printing, such as a state during transportation, and FIG. 3(b) shows the film cassette in a printing state where the film cassette is inserted in a thermal transfer printer for printing. Basically, the respective operating modes of the feed bobbin 40 and the takeup bobbin 50 are the same and hence description will be concentrated on the operating mode of the feed bobbin 40.

Referring to FIG. 3(a), when the film cassette is not used for printing, the free end of the shaft 40b of the feed bobbin 40 touches the positioning tongue 20b of the second half case 20 and thereby the feed bobbin 40 is restrained from axial movement in the direction of the arrow C. In this nonprinting state, the projection 10a of the first half case 10 remains engaged in the groove 40a of the wheel 40c of the feed bobbin 40 until a releasing force exceeding a predetermined level is applied to the feed bobbin 40. Thus the feed bobbin 40 is restrained from being turned by vibrations or the like during transportation and hence the thermal transfer film 30 does not slacken.

Referring to FIG. 3(b), when the film cassette is used for printing, the feed bobbin 40 is pushed axially in the direction of the arrow C by a driving member, not shown, included in the thermal transfer printer. Consequently, the positioning tongue 20b of the second half case 20 is warped by the shaft 40b of the feed bobbin 40. Since the positioning tongue 20b is formed of an elastic material, the positioning tongue 20b is warped like a plate spring. When a releasing force exceeding a predetermined level is applied to the feed bobbin 40, the feed bobbin 40 moves to a position shown in FIG. 3(b) and the projection 10a of the first half case 10 is disengaged from the groove 40a of the wheel 40c of the feed bobbin 40. Consequently, the feed bobbin 40 can be turned by the driving member, not shown, of the thermal transfer printer as the need arises.

When the film cassette set in the printing state as shown in FIG. 3(b) is removed from the thermal transfer printer, the film cassette is able to return to the nonprinting state shown in FIG. 3(a).

The positioning tongues 20b for positioning the feed bobbin 40 and the takeup bobbin 50 in the first half case 10 and the second half case 20 are formed integrally with the second half case 20. The positioning tongues 20b positions the feed bobbin 40 and the takeup bobbin 50 such that the projections 10a of the first half case 10 are kept engaged in the grooves 40a and 50a of the wheels 40c and 50c of the feed bobbin 40 and the takeup bobbin 50 until a releasing force exceeding a predetermined level is applied to the feed bobbin 40 and the takeup bobbin 50. Thus the slackening of the film 30 during the transportation of the film cassette can be effectively prevented and the film cassette consists of a relatively small number of parts and can be easily assembled.

The feed bobbin 40 and the takeup bobbin 50 are held so as to be axially movable in the first half case 10 and the second half case 20 and the positioning tongues 20b touch the free end of the shafts 40b and 50b of the feed bobbin 40 and the takeup bobbin 50 to position the feed bobbin 40 and the takeup bobbin 50. Thus the slackening of the film 30 during the transportation of the film cassette can be surely prevented.

Since the positioning tongues 20b are not warped or deformed and remain in a natural shape while the releasing force is not applied to the feed bobbin 40 and the takeup bobbin 50, the film cassette can be easily assembled.

The first half case 10 is provided with the bearing parts 10b for supporting the shafts 40b and 50b of the feed bobbin 40 and the takeup bobbin 50, and the positioning tongues 20b for positioning the feed bobbin 40 and the takeup bobbin 50 in the first half case 10 are formed integrally with the second half case 20 to be joined to the first half case 10. Therefore, the second half case 20 can be put on and joined to the first half case 10 by easy assembling work.

Furthermore, the first half case 10 is provided with the hooks 12 which engage the second half case 20 to join the first half case 10 and the second half case 20 together. Thus, the second half case 20 can be easily and surely joined to the first half case 10. Since the hooks 12 formed integrally with the first half case 10 are elastic, the film cassette can be easily and surely assembled without requiring additional parts and special tools and devices.

### Modifications

Although the film cassette in the preferred embodiment has been described with reference to FIGS. 1 to 3, the present invention is not limited to the embodiment in its practical application and the following various changes and modifications are possible.

(1) The film cassette may hold a roll of any one of various kinds of films for various purposes instead of the thermal transfer film for thermal transfer printing.

(2) The positioning tongues 20b may be warped or deformed to a predetermined extent to exert a predetermined force on the feed bobbin 40 and the takeup bobbin 50 in the nonprinting state instead of being kept in a free state where the positioning tongues 20b are not warped or deformed. The positioning tongues 20b thus warped or deformed are able to prevent the rattling motions of the feed bobbin 40 and the takeup bobbin 50 during transportation effectively.

(3) Although both the feed bobbin 40 and the takeup bobbin 50 of the film cassette in the aforesaid embodiment are restrained from rotation in the nonprinting state, such as a state during transportation, only either the feed bobbin 40 and the takeup bobbin 50 may be restrained from rotation. Preferably, the feed bobbin 40 is restrained from rotation.

(4) The positioning tongues 20b formed integrally with the second half case 20 position the feed bobbin 40 and the takeup bobbin 50, and the first half case 10 and the second half case 20 are fastened together by the hooks 12 formed integrally with the first half case 10 and engaging in the recesses 20c in the aforesaid embodiment. However, an arrangement associated with the positioning tongues 20b and that associated with the hooks 12 (and the recesses 20c) can be individually practiced. That is, the feed bobbin 40 and the takeup bobbin 50 may be positioned by the positioning tongues 20b formed integrally with the second half case 20, and the first half case 10 and the second half case 20 may be welded together by ultrasonic welding or fastened together by additional fastening members. Furthermore, the first half case 10 and the second half case 20 may be fastened together by the engagement of the hooks 12 formed integrally with the first half case 10 in the recess 20c and the feed bobbin 40 and the takeup bobbin 50 may be positioned by metal plate springs attached to the package. When joining together the first half case 10 and the second half case 20, the first half case 10 and the second half case 20 may be temporarily joined together with hooks formed integrally with the first half case 10 or the second half case 20 and the first half case 10 and the second half case 20 may be fastened together by ultrasonic welding or the like.

(5) Although the first half case 10 and the second half case 20 forming the package of the aforesaid embodiment are parted by a substantially flat plane parallel to the axes of the feed bobbin 40 and the takeup bobbin 50, the first half case 10 and the second half case 20 may be parted by a plurality of three-dimensionally combined planes.

(6) The positioning tongues 20b which are warped while the film cassette is in the printing state restore their original shapes and suppress the rotation of the feed bobbin 40 and the takeup bobbin 50 when the film cassette is returned to the nonprinting state. The positioning tongues 20b may be plastically deformed or broken when the film cassette is inserted in a thermal transfer printer and may be unable to restore their original shapes. When the film cassette is used on a device that does not need to change the film cassette unless all the length of the thermal transfer film is used and it is difficult to provide the film cassette with sufficiently elastic positioning tongues, a film cassette provided with the permanently deformable or breakable positioning tongues can be satisfactorily used.

(7) The positioning tongues 20b may be formed integrally with the first half case 10 instead of being formed integrally with the second half case 20. The hooks 12 may be formed integrally with the second half case 20 instead of being formed integrally with the first half case 10.

(8) The positioning tongues 20b of the aforesaid embodiment are formed integrally with the second half case 20 of the same material. The positioning tongues 20b may be formed on a material different from that forming the second half case 20 and may be combined with the second half case 20 by insert molding. The hooks 12 of the aforesaid embodiment are formed integrally with the first half case 10. The hooks 12 may be formed of a material different from that forming the first half case 10 and the hooks 12 may be combined with the first half case 10 by insert molding.

What is claimed is:

1. A film cassette comprising:
a feed bobbin holding a length of film;
a takeup bobbin capable of taking up the film unwound from the feed bobbin;
a package having first and second half cases and holding the feed bobbin and the takeup bobbin therein; and
a detaining mechanism for restraining at least the feed bobbin or the takeup bobbin from rotation in the first and the second half case by engaging at least either the feed bobbin or the takeup bobbin with at least either the first half case or the second half case;
wherein at least either the first half case or the second half case is provided integrally with a positioning tongue for positioning at least either the feed bobbin or the takeup bobbin in the first and the second half case, and the positioning tongue positions at least either the feed bobbin or the takeup bobbin such that the detaining mechanism remains engaged until a releasing force exceeding a predetermined level is applied to at least either the feed bobbin or the takeup bobbin.

2. The film cassette according to claim 1, wherein at least either the feed bobbin or the takeup bobbin is axially movable in the first and the second half case, and the positioning tongue is in contact with an end of at least either the feed bobbin or the takeup bobbin to fix the axial position of at least either the feed bobbin or the takeup bobbin.

3. The film cassette according to claim 2, wherein the positioning tongue is not warped or deformed and held in a free state while the releasing force is not applied to at least either the feed bobbin or the takeup bobbin.

4. The film cassette according to claim 2, the positioning tongue is warped or deformed by a predetermined amount to apply a predetermined biasing force to at least either the feed bobbin or the takeup bobbin when the releasing force is not applied to at least either the feed bobbin or the takeup bobbin.

5. The film cassette according to any one of claims 1 to 4, wherein the first half case is provided with bearing parts for supporting shafts of the feed bobbin and the takeup bobbin, and the second half case to be joined to the first half case is provided integrally with the positioning tongue for positioning at least either the feed bobbin held in the first half case or the takeup bobbin held in the first half case.

6. The film cassette according to any one of claims 1 to 5, wherein at least either the first half case or the second half case is provided with fastening means for fastening together the first and the second half case.

7. The film cassette according to claim 6, wherein the fastening means are a plurality of elastic hooks formed at least on either the first half case or the second half case.

8. The film cassette according to claim 1, wherein the length of film is a thermal transfer film.

9. A film cassette comprising:
a feed bobbin holding a length of film;
a takeup bobbin capable of taking up the film unwound from the feed bobbin; and
a package having first and second half cases and holding the feed bobbin and the takeup bobbin therein;
wherein at least either the first half case or the second half case is provided with fastening means for fastening together the first and the second half case.

10. The film cassette according to claim 9, wherein the fastening means are a plurality of elastic hooks formed integrally with at least the first half case or the second half case.

11. The film cassette according to claim 9, wherein the length of film is a thermal transfer film.
